(19) United States
(12) Patent Application Publication
(10) Pub. No.: US 2011/0137889 A1
(43) Pub. Date: Jun. 9, 2011

(54) System and Method for Prioritizing Data Storage and Distribution

(75) Inventor: Howard Israel Nayberg, Plainview, NY (US)

(73) Assignee: CA, Inc.

(21) Appl. No.: 12/633,865

(22) Filed: Dec. 9, 2009

(51) Int. Cl. G06F 17/30

(52) U.S. Cl. 707/713; 707/E17.017

(57) ABSTRACT

Various systems and methods for prioritizing data storage and distribution by a data prioritizer device are provided. For example, the data prioritizer device may receive from a consumer a registration that includes one or more record identifiers, which identify one or more data records in which the consumer is interested. The data prioritizer device may receive from a producer a data record identified by a record identifier and store the data record when the record identifier is among the one or more record identifiers, thereby storing the data record when the consumer has indicated an interest in the data record. The data prioritizer device may queue the data record in a consumer queue allocated for the consumer and provide the data record to the consumer from the consumer queue.

### FIELD OF THE INVENTION

The invention relates generally to managing distribution of data and more particularly to prioritizing data storage and distribution with an efficient use of system resources such as processor utilization, operating system overhead, memory and the paging subsystem.

### BACKGROUND OF THE INVENTION

Various computing systems such as an event management system may include producers that generate and may store a large number of data records in different parts of the system. For example, the event management system may include event producers or listeners that generate 3,000 or more event records per second. These events may be distributed in real-time to event consumers for immediate analysis and/or stored by the consumers for future analysis. The event records may be data records that describe network, security, changes, or other events occurring in various parts of the enterprise-wide computing system. Each consumer may have an interest in one or more event types, or possibly all event types.

Providing the data records to consumers who are interested in the data records may be problematic due to the shear quantity (i.e., volume and/or size) and/or distribution of the data records. For instance, in order to make the data records available to all consumers, the data records may be collected from various local repositories or producers and stored in a common repository that is accessible to all consumers. However, given the quantity of data records that the computing system may generate, the size of the common repository needed to store the data records may be prohibitively large. Furthermore, in some computing systems, a number of the data records may not be interesting to any consumer, thereby wasting storage capacity and computational resources used by the producer to prepare uninteresting data records for a common repository or a consumer to examine numerous records for which it does not have an interest.

Common memory areas are a limited resource in many computing systems. Using large areas of common memory may put critical system functions at risk of failure even with the most intermittent shortages of this class of memory. The nature of these data records which can be very large (in excess of 2²⁴−1 bytes) prohibits the use of such memory areas for storing of these data record for even the shortest of intervals.

In the event management system described above, consumers such as event managers may use particular event records for event correlation and other event-based activities. For example, a network security event manager may be interested in a particular event record that may be related to a network intrusion event while not interested in an event record related to mundane, low-level, network activity. Thus, storing an event record related to mundane network activity in a common database may be inefficient.

Furthermore, there may exist a security risk when common memory areas are used to transfer data records between separate and distinct private memory areas within the computing system. A rouge program may examine and extract sensitive data when that data resides in a common memory area. This risk may be mitigated by using private storage and directly transferring data between private storage areas without exposing the data in a commonly accessible memory area.

Certain types of data records such as security related information or a pending item which requires immediate action should be quickly reported to the consuming application. Simply placing these data records in a repository for later consumption, even short term may not be acceptable. These types of data records may be produced when the computing system is being stressed due to near full capacity processing. The resources used to notify the final consumer that the data record exists and to transfer the record to the consumer should be minimized.

Existing systems attempt to address such problems by employing post-wait techniques, where the consumer posts a request to the system to provide certain data records. Once the system recognizes the request, the system may attempt to locate, retrieve, then provide the data records if they are available. However, such systems are inefficient because of, for example, context switching used to process the request (receive the request, locate the data, retrieve the data, provide the data, etc.). Because context switching may consume more computing resources than processing events, context switching may present a burden on computing systems. These inefficiencies may be compounded when system loads are high.

These and other drawbacks exist.

### SUMMARY OF THE INVENTION

Various systems and methods for prioritizing data storage and distribution by a data prioritizer device are provided. For example, the data prioritizer device may receive from a consumer a registration that includes one or more record identifiers that identify one or more data records in which the consumer is interested. The data prioritizer device may receive from a producer a data record identified by a record identifier and store the data record when the record identifier is among the one or more record identifiers, thereby storing the data record when the consumer has indicated an interest in the data record. The data prioritizer device may queue the data record in a consumer queue allocated for the consumer and provide the data record to the consumer from the consumer queue. Thus, various systems and methods may facilitate, among other things, efficient, scalable and secure creation, storage, and distribution of data records.

### BRIEF DESCRIPTION OF THE DRAWINGS

FIG. 1 is a block diagram of a system for prioritizing data storage and distribution, according to an aspect of the invention.

FIG. 2 is a block diagram of a data storage repository for data prioritization, according to an aspect of the invention.

FIG. 3 is a flow diagram of a process for prioritizing data storage and distribution, according to an aspect of the invention.

FIG. 4 is a flow diagram of a process for receiving a registration from a consumer.

FIG. 5 is a flow diagram of a process for receiving data from a producer, according to an aspect of the invention.

FIG. 6a is a flow diagram of a process for queuing a data record for delivery to a consumer, according to an aspect of the invention.

FIG. 6b is a flow diagram of a process for queuing a data record for delivery to a consumer, according to an aspect of the invention.

FIG. 7 is a flow diagram of a process for providing data to a consumer, according to an aspect of the invention.

### DETAILED DESCRIPTION OF THE INVENTION

Various implementations of the invention relate to systems and methods for prioritizing data storage and distribution. For example, the system may include a prioritizer that receives a registration from a consumer. The registration may include one or more event identifiers that identify one or more event records in which the consumer is interested. The prioritizer may receive an event record, which may be identified by an event identifier, from a producer. The prioritizer may store the event record when the event identifier is among the one or more event identifiers, thereby storing the event record when the consumer has indicated interest in the event record. Thus, the event record may be stored by the prioritizer when at least one consumer has registered an interest in the event record. The prioritizer may notify the consumer when the event record has been stored and receive a request from the consumer to provide the data record. Based on the request, the prioritizer may provide the data record to the consumer in response to the request.

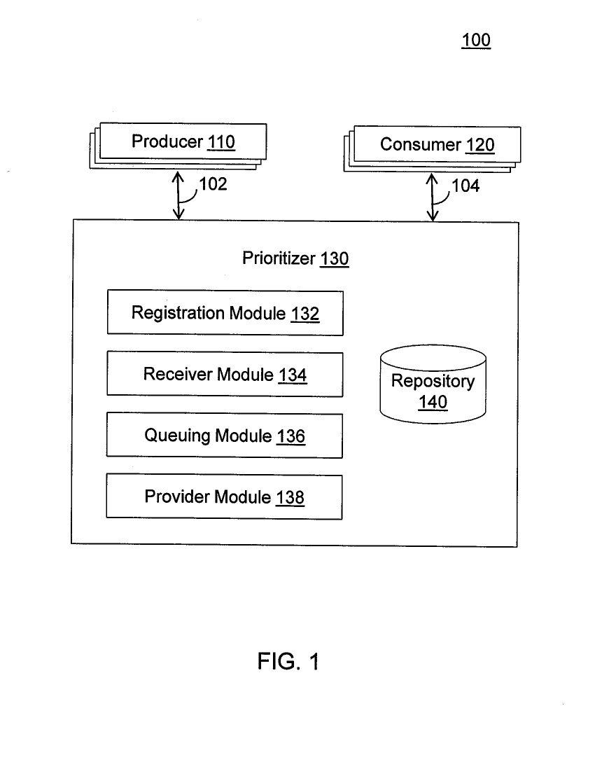

FIG. 1 is block diagram of a system 100 for prioritizing data storage and distribution, according to an aspect of the invention. System 100 may include, for example, one or more producers 110 (hereinafter “producer 110” or “producers 110”), one or more consumers 120 (hereinafter “consumer 120” or “consumers 120”), a prioritizer 130, and a repository 140. Prioritizer 130 may be communicably coupled to producer 110 and consumer 120 via communication links 102 and 104. Communication links 102 and 104 may include, for example, memory to memory transfer, a network such as the Internet, an Ethernet, combination of networks, and/or other communication link that facilitates data communication.

According to various implementations of the invention, producer 110 includes a computing device that generates one or more data records. For example, producer 110 may include a computing device configured as an event listener that monitors the occurrence of network events and generates one or more data records to record the occurrence of such network events. In some implementations, producer 110 may generate a large number of data records such as, for example, 2500 or more records per second. In some implementations, each data record may have a size exceeding 2²⁴−1 data bytes. However, one having skill in the art will recognize that different numbers or sizes of data records may be produced. For example, various computing systems may have different memory or other constraints that affect the number and/or size of the data records that may be managed.

According to various implementations of the invention, the data records may vary in size. In some implementations, at least some of the data records are less than approximately eight kilobytes. Each data record may be identified by a record identifier. Thus, various components of system 100 may identify a particular data record using its record identifier. In some implementations, a format of the data record may be unrestricted so long as certain fields of the data record are maintained. For example, so long as the first two fields of the data record are fixed and include certain information, the data record may be in any format. In some implementations, the first field is fixed length and includes an unsigned 32-bit value (other values may be used as appropriate) representing the length of the data record. In some implementations, the second field is 16-bit (other values may be used as appropriate) unsigned value representing the record identifier for the data record. Thus, producer 110 and consumer 120 may upload and retrieve data records in substantially any format.

According to various implementations of the invention, consumer 120 includes a computing device that requests at least one data record. In some implementations, consumer 120 may be interested in only a subset of the data records available to it. For example, consumer 120 may include a computing device configured as an event manager that analyzes one or more event records for various purposes such as event correlation. The event manager may be interested in only particular event records of system 100 such as when investigating a particular network security risk or potential network security risk. Thus, in some implementations, consumer 120 may indicate an interest in some data records but not other data records. In other implementations, consumer 120 may indicate an interest in all data records.

According to various implementations of the invention, consumer 120 may register to receive the one or more data records in which it is interested from prioritizer 130. The registration may include an indication of one or more record identifiers, or an indication that all data records are to be presented without regard for identification, for example, of data records in which consumer 120 is interested. In some implementations, the registration may include an instruction to prioritizer 130 that indicates consumer 120 would like to be notified when the data records are available. For example, the registration may include an event control block (ECB) that is used to notify consumer 120 when the one or more record identifiers that consumer 120 registered are available.

According to various implementations of the invention, consumer 120 may allocate one or more buffers in a memory (not otherwise illustrated in FIG. 1) of consumer 120 for receiving the data records from prioritizer 130. In this manner, prioritizer 130 may not be required to allocate system memory for the one or more buffers used by consumer 120 for receiving the data record, thereby minimizing use of system resources.

According to various implementations of the invention, through various modules, prioritizer 130 may prioritize storage and distribution of data records generated by producer 110, thereby minimizing common storage and/or system load. In some implementations, prioritizer 130 may include, among other things, a registration module 132, a receiver module 134, a queuing module 136, a provider module 138, and a repository 140.

According to various implementations of the invention, registration module 132 may receive a registration of which data records are interesting to consumer 120. Thus, in some implementations, prioritizer 130 may determine which data records to store or otherwise make available to consumer 120. In some implementations, prioritizer 130 may determine particular data records to purge from storage when consumer 120 is not interested in the particular data records. For example, consumer 120 may have updated a registration for a data record to indicate that consumer 120 is no longer interested in the data record. In this scenario, storing the data record is no longer necessary and may be purged.

According to various implementations of the invention, receiver module 134 may receive data records from producer 110. In some implementations, receiver module 134 may allocate a buffer in a memory (not otherwise illustrated in FIG. 1) or select a buffer from a pre-allocated pool to receive the data records, then store the data records in repository 140.

According to various implementations of the invention, queuing module 136 may queue data records for delivery to consumer 120. Queuing module 136 may queue the data records to a consumer queue by copying the data records from repository 140. In some implementations, when queuing the data records, queuing module 136 may use a buffer that is pre-allocated for consumer 120. The data records may be copied from the pre-allocated buffer (allocated by queuing module 136) to the consumer queue. According to various implementations of the invention, provider module 138 may provide the data records from the consumer queue to consumer 120. In some implementations, provider module 138 may notify consumer 120 that the data records are available. Provider module 138 may provide the data records to consumer 120 by filling a consumer buffer at consumer 120. In some implementations, the consumer buffer is provided by consumer 120.

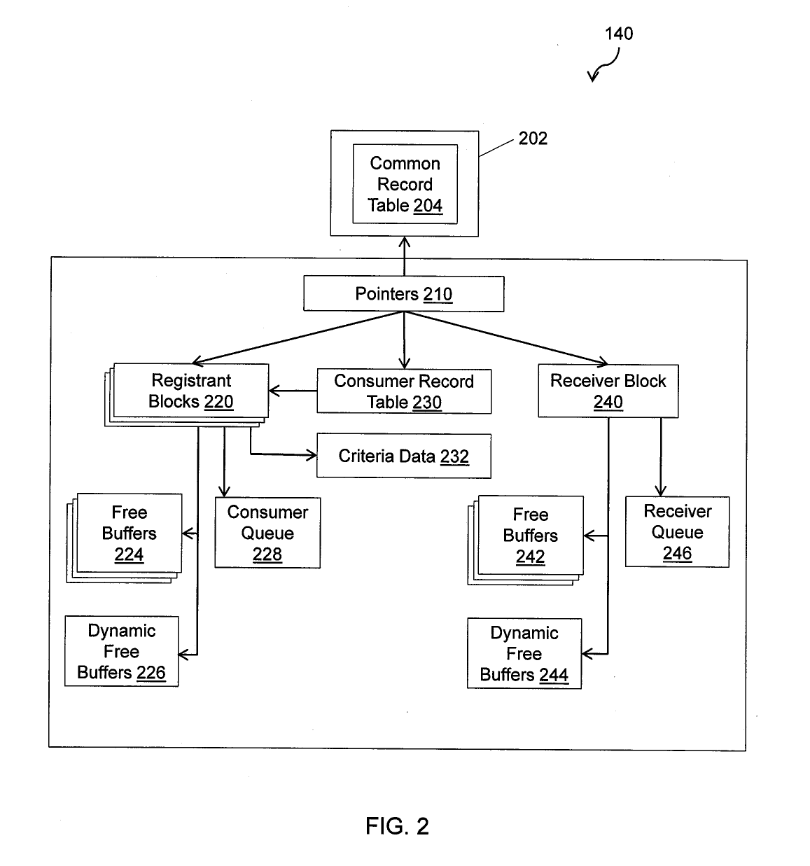

FIG. 2 is block diagram of a data storage repository 140 for data prioritization, according to an aspect of the invention. Data storage repository 140 may include, for example, a common storage 202 and a prioritizer storage 206.

According to various implementations of the invention, common storage 202 may identify data records for which consumer 120 has indicated an interest. In some implementations, common storage 202 includes a common record table 204 that stores registration information from consumer 120, thereby identifying the data records in which consumer 120 is interested. For a given data record, for instance, common record table 204 may indicate whether consumer 120 is interested in the data record. In these implementations, common record table 204 may be a bit table that includes a number of bits equal to M+1, where M is the maximum record identifier such that a bit may correspond to a record identifier. When a particular bit is set to “on” (typically, by having a value of 1) then at least one consumer 120 has indicated an interest in the corresponding record identifier. In some implementations, the bit at offset zero may be reserved to indicate that at least one consumer 120 has indicated an interest in all data records. Thus, common record table 204 may be used to efficiently identify data records in which at least one consumer 120 has indicated an interest while leaving a minimal memory footprint.

In some implementations, producer 110 may access common record table 204 to quickly identify which data records are interesting to consumer 120. For example, prioritizer 130 may receive a record identifier from producer 110 and in response communicate information indicating whether the data record corresponding to the record identifier is interesting to consumer 120. According to this implementation, producer 110 may decide whether to package and/or submit a given data record to prioritizer 130 based on whether the data record is interesting.

The preceding implementations of common storage 202 and common record table 204 are illustrative only and not intended to be limiting. Those having skill in the art would appreciate that other configurations and implementations may be used.

According to various implementations of the invention, prioritizer storage 206 stores information related to data records received from producer 110 and/or registration information from consumer 120. Prioritizer storage 206 may include pointers 210 that provide information couplings between common record table 204, registrant blocks 220, consumer record table 230, and receiver blocks 240, thereby enabling efficient indexing and retrieval of data records received from producer 110 and data records registered by consumer 120.

According to various implementations of the invention, registrant blocks 220 may be generated when consumers 120 register an interest in data records. For example, when a consumer 120 registers an interest in a particular data record identified by record identifier, a registrant block 220 may record the interest such as by storing an identifier of consumer 120, which may be pointed to by consumer record table 230. Registrant blocks 220 may anchor a consumer queue 228, which includes a queue of data records for which consumer 120 has indicated an interest. Thus, registrant blocks 220 may be used to build or otherwise maintain consumer queue 228, which may be used to queue data records for which consumer 120 has indicated an interest.

According to various implementations of the invention, registrant blocks 220 may be linked to consumer record table 230 and receiver block 240 by pointers 210. In this manner, registration information and consumers 120, may be accessed in aggregate by a record identifier of interest, thereby enabling efficient identification of interested consumers for a data record corresponding to the record identifier of interest and queuing of the data record to consumer queue 228 for consumer 120.

In some implementations, consumer record table 230 may include an aggregate of all consumers 120 by record identifier that have indicated an interest in one or more data records. For example, given record identifier of interest, consumer record table 230 may be used to list pointers to registrant blocks 220, thereby efficiently identifying consumers 120 that have indicated an interest in a data record identified by the record identifier. In some implementations, consumer record table 230 may include a reserved value, such as zero or other reserved value, that indicates a consumer 120 associated with the reserved value has indicated an interest in all data records without regard for record identifier.

According to various implementations of the invention, consumer record table 230 may be formatted to enable rapid identification of consumers 120 that are interested in a particular data record. In some implementations, the anchor to consumer record table 230 is maintained in a master control block, which is always addressable.

In some implementations, consumer record table 230 may be portioned such that different portions of consumer record table 230 represent different information. For example, each index entry may be stored as contiguous 16-byte entries. This and other example sizes are examples only and not intended to be limiting in any way. Those having skill in the art would appreciate that other sizes may be used and adjusted accordingly. In some implementations, a 16-byte entry may be reserved for “all” data records. In some implementations, the first 16-byte entry may be reserved for this “all” indication.

In some implementations, an index entry in consumer record table 230 may include an 8 byte value representing a number of consumers 120 interested in the particular data record and a 8 byte pointer to a block that includes addresses of registration blocks (of registrant blocks 220) for consumers 120 interested in the particular data record. The values may be sized according to particular needs. In some implementations, the values are approximately 8 bytes each. Thus, the entry may be used to rapidly identify the number of consumers 120 interested in the particular data record and registration information for those consumers 120.

In some implementations, a block of consumer addresses may be formatted such that the first 8 byte entry is a pointer to the next block of consumers 120 interested in a particular data record or zero. The remaining entries in the block are 8 byte pointers to the registration block of a particular consumer 120. As previously noted, these sizes are examples only and may be configured according to particular needs. Whatever size is selected, the size of the block should be such that substantially all consumers expected to be interested in a particular data record should be included in a single block. In the preceding example, a single 256 byte block may include (256−8)/8 consumers 120. In order to quickly identify consumers 120 interested in a particular record, the record identifier is multiplied by the size of the index entry and added to the base address of the index, thereby computing the address of the index entry in question. In this manner, given an input record identifier, the number of consumers 120 interested in the data record and the location of said consumers 120 registration block 220 corresponding to the record identifier may be rapidly determined.

In some implementations, registrant blocks 220 may point to criteria data 232 via pointers 210. Criteria data 232 is used to further determine whether consumer 120 is interested in a particular data record. In other words, upon identifying a data record based on a record identifier for which consumer 120 has registered an interest, criteria data 232 may be used to test whether consumer 120 should receive the data record. For example, criteria data 232 may include information related to bit tests, character comparisons, and other tests for prioritizer 130 to perform as defined by consumer 120 in order to determine whether consumer 120 is to receive the data record. In some implementations, criteria data 232 includes instructions to prioritizer 130 (such as whether to purge or store particular data records) based on whether criteria have been met.

In some implementations, receiver block 240 may include blocks of data configured to store information related to producers 110 that submit data records for storage. The blocks of data may be configured in a similar manner to that described above with regard to registrant blocks 220. A receiver queue 246 may be used to queue data records received from producers 110, thereby organizing and controlling data records from various producers 110.

In some implementations, free buffers 224 and 242 used to process registrant blocks 220 and receiver block 240, respectively, may be pre-allocated. This pre-allocation may minimize overhead associated with memory allocation and de-allocation. In some implementations, CPOOL Macro on the z/OS architecture may be used. In some implementations, dynamic free buffers 226 and 244 may be dynamically allocated and used to process data records on queues anchored from registrant blocks 220 and receiver block 240, respectively. In some implementations, use of dynamic free buffers 225 and 244 may be used less than free buffers 224 and 242 in order minimize overhead of memory allocation and de-allocation.

In some implementations, CPOOL Macro on the z/OS architecture may be used to maintain index records that point to larger (as compared to the index records) buffers that contain actual data records. These larger buffers, in some implementations, may be maintained in 64-bit addressable storage (commonly referred to as ‘above the bar’). Because the index records are smaller than the larger buffers, large data records may be accommodated in the larger buffers while queue manipulation is confined to a smaller working set of index records.

In some implementations, the larger buffers pointed to by index records may be carved out of memory objects as large or larger than 5 megabytes. These buffers, which may be of varying sizes, are allocated on an as needed basis from the next available unassigned byte of storage within the larger block, but once allocated, remain static. This method allows for more efficient use of storage for any given implementation based on the sizes of, and frequency of occurrence of, various sized records then would otherwise be achieved with various fixed size buffer pools.

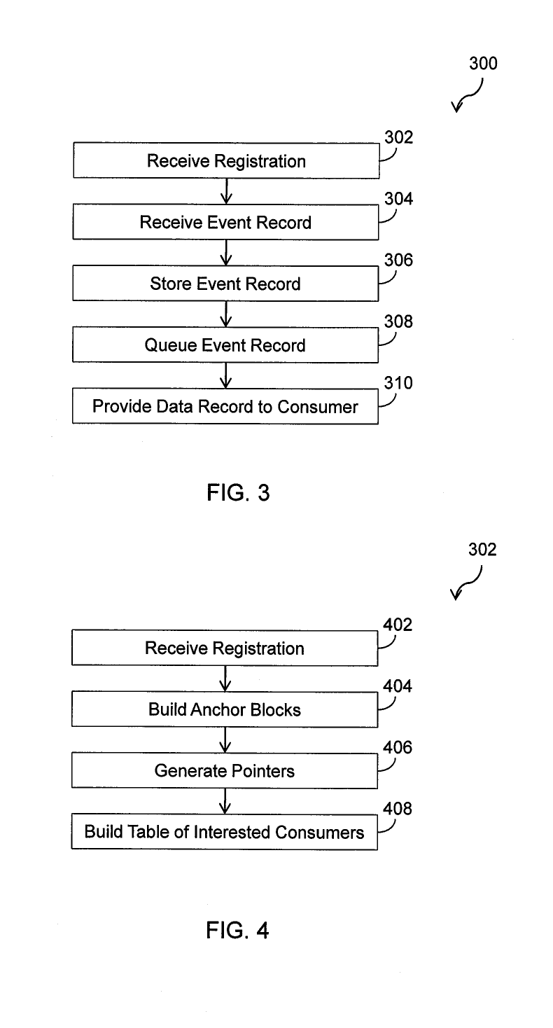

FIG. 3 is a flow diagram of a process 300 for prioritizing data storage and distribution, according to an aspect of the invention. The various processing operations depicted in the flow diagram of FIG. 3 (and in the other drawing figures) are described in greater detail herein. The described operations for a flow diagram may be accomplished using some or all of the system components described in detail above and, in some implementations, various operations may be performed in different sequences. According to various implementations of the invention, additional operations may be performed along with some or all of the operations shown in the depicted flow diagrams. In yet other implementations, one or more operations may be performed simultaneously. Accordingly, the operations as illustrated (and described in greater detail below) are examples by nature and, as such, should not be viewed as limiting.

In an operation 302, process 300 may receive a registration from consumer 120. The registration may identify one or more data records such as event records in which consumer 120 is interested. In an operation 304, an event record may be received. The event record may be identified by a record identifier such as an event identifier. In an operation 306, the event record may be stored when it is determined that consumer 120 is interested in the event record. Thus, instead of storing all event records, process 300 may store data records that at least one consumer 120 has registered. In an operation 308, the data record may be queued in a consumer queue designated for consumer 120. In an operation 310, the data record may be provided to the consumer from the consumer queue.

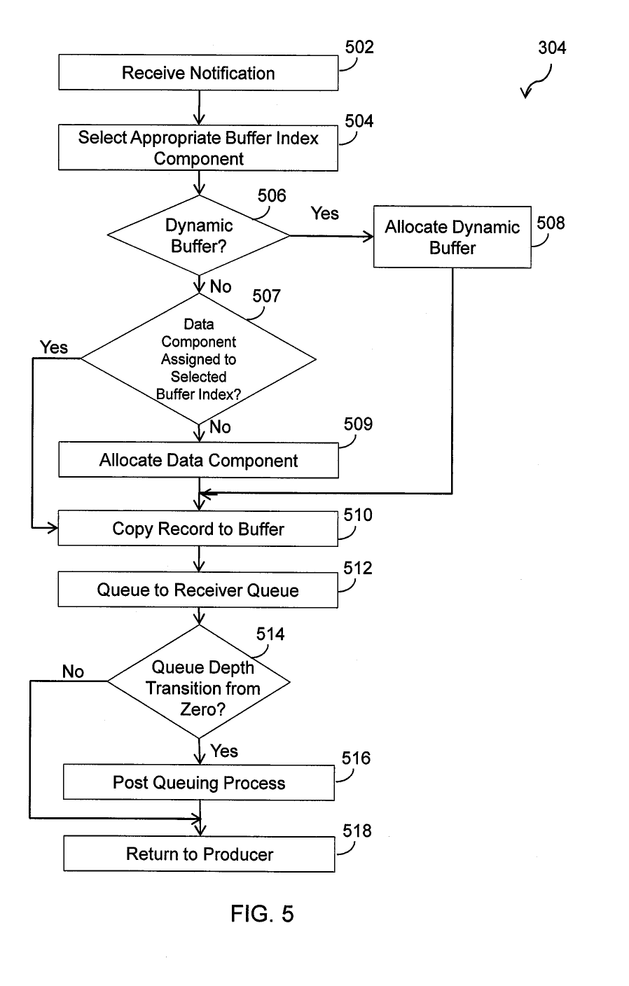

FIG. 4 is a flow diagram of a process 302 for receiving a registration from consumer 120, according to an aspect of the invention. In an operation 402, process 302 may receive a registration from consumer 120. The registration may identify one or more record identifiers in which consumer 120 is interested, simple compares such as bit tests and compare character tests, and/or other information related to data records. In an operation 404, process 302 may build a registration block to anchor the consumer queue designated for consumer 120. In an operation 406, process 302 may add pointers to enable efficient distribution to consumer 120. The pointers may be used to quickly identify consumers 120 registered and the associated consumer queue for consumer 120 that has expressed interest in the given record identifier being processed. In an operation 406, process 302 may build common record table 204 that a producer 110 may use to quickly determine whether there is an interest by one or more consumers 120 for a given data record.

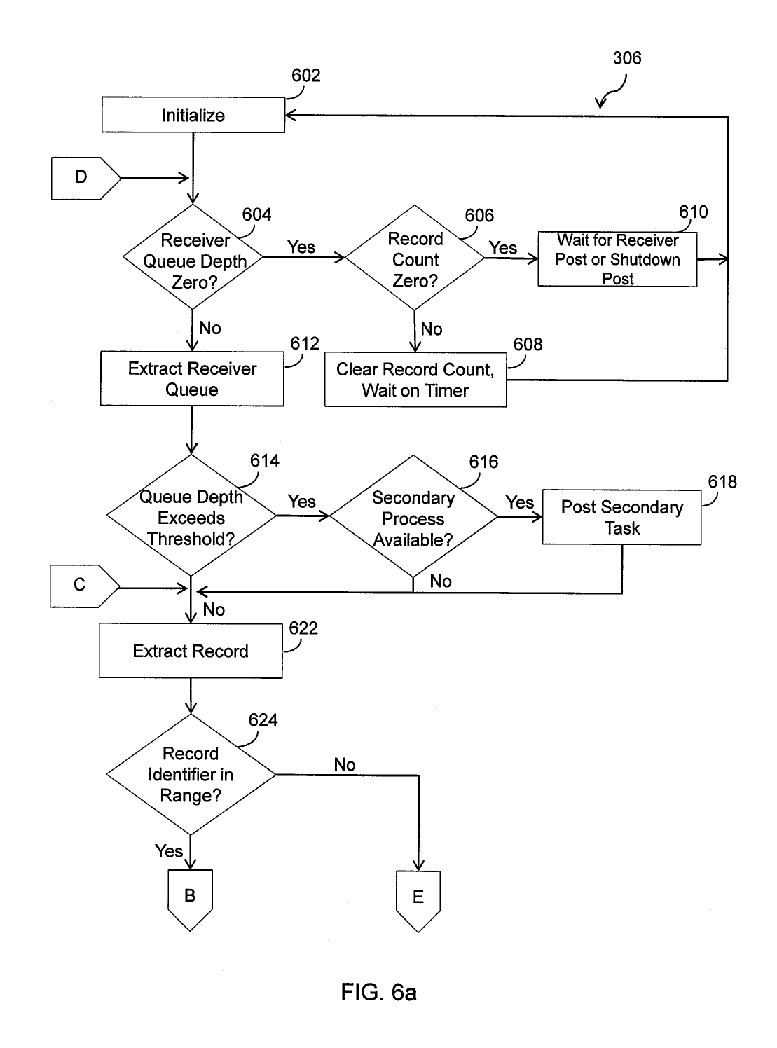

FIG. 5 is a flow diagram of a process 304 for receiving data from producer 110, according to an aspect of the invention. In an operation 502, process 304 may receive a notification that a data record is available. For example, the notification may be made via a call to an Applications Program Interface (API). In some implementations, process 304 may be executed by producer 110, thereby addressing the problem of context switching. The notification may include an address of the data record to be posted. In this implementation, producer 110 may issue a cross-memory program call, passing the address of the data record in its local storage (which may be referred to as the secondary address space from the perspective of the prioritizer) in general register one. In other implementations, producer 110 in addition to passing the address of the data record in general register one, may also pass an ALET in access register one, which identifies the space in which the data record exists (note the necessary structures and definitions, such as but not limited to the ALET being present on the DU-AL structures of the process identifying the data record the prioritizer, which are required for the ALET to be valid for use by the prioritizer must be in place and are out the scope of this invention). In some implementations, an authorization to ensure that producer 110 is authorized to post the data record may be performed. In these implementations, performance may be affected by such authorization validation. Whether authorization validation is performed or not, in an operation 504, an appropriate buffer index component may be selected based on a size (such as number of bytes) of the data record. For example, a buffer may be selected from among predefined buffer pools based on the size of the data record.

In an operation 506, when the size of the data record exceeds a maximum size for the predefined buffer pools, processing may proceed to an operation 508, wherein a dynamic buffer may be allocated and selected as the buffer. Processing may proceed to an operation 510, wherein the data record is copied to the selected buffer. Returning to operation 506, when the size of the data record does not exceed the maximum size, processing may proceed to an operation 507, wherein a determination is made whether a buffer data component has been assigned to the buffer index component. In some implementations, this determination may include whether the buffer index component has been initialized. If not inititialized, the buffer index component may be initialized by, for example, placing the storage pool token in the buffer index record, thereby enabling an efficient manner for returning the buffer index component to the free queue on which it belongs. In operation 507, when it is determined that a buffer data component has previously been assigned to the buffer index component, processing may proceed to operation 510. On the other hand, in operation 507, when it is determined that a buffer data component has not been assigned to the buffer index component, processing may proceed to an operation 509, wherein a buffer data component will be assigned to the buffer index component and processing may proceed to operation 510.

In an operation 512, the data record may be queued on a receiver queue. In some implementations, the data record includes a buffer index component for locating or otherwise indexing the data record and a buffer data component for storing the data. In these implementations, the buffer index component includes queue management pointers. In some implementations, the receiver queue is Last-In-First-Out (LIFO) for efficiency thus enabling a faster queuing process as compared to First-In-First-Out (FIFO) which in turn may enable producer 110 to more rapidly return to other operations. In some implementations, the receiver queue is FIFO, thereby enabling data records to appear in chronological order except as affected by operating system dispatching and scheduling of producer 110 processes. In some implementations, the data records from a single process may not appear in the receiver queue in chronological order. In some implementations, data records that are produced by different processes may not appear in the receiver queue in chronological order, but data from the same processes may appear in chronological order.

In an operation 514, when a queue depth transitions from zero to one (i.e., a data record is not currently queued on the receiver queue for delivery to a consumer queue at the time the data record being processed is added), processing may proceed to an operation 516, wherein the queuing process is posted to process the data record for delivery to a consumer queue. Returning to operation 514, when the queue depth does not transition from zero to one, an actual post may not be required and processing may proceed to an operation 518 described below.

In some implementations, the queuing process may be posted using compare and swap logic, as described in IBM Authorized Assembler Guide.

In some implementations, the queuing process may be actively posted, appear to be running, or waiting on a timer under a different ECB. When actively posted, or appear active, or waiting on a timer under a different ECB, the queuing task may appear active from the perspective of the post function described in operation 516 and an actual post may not be necessary which may provide significant performance gains. When in a wait state from the perspective of the post logic in operation 516, an actual post request may be required and issued to awaken the queuing process.

Whichever implementation for posting the data record is used, processing may proceed to operation 518, wherein control is returned to producer 110.

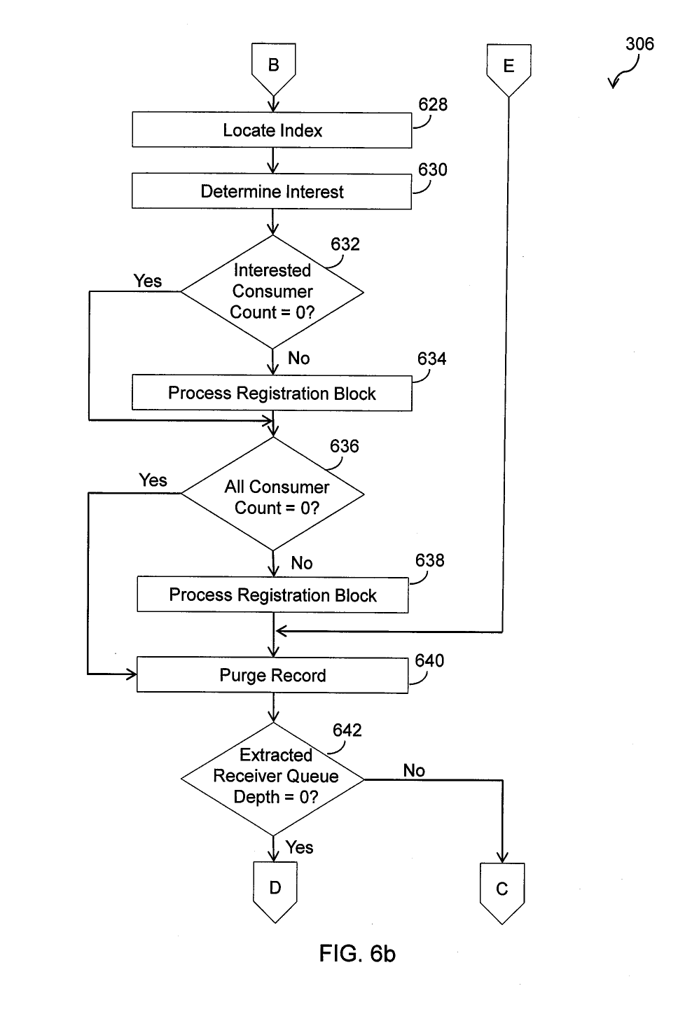

FIGS. 6a and 6b is are flow diagrams of a process 306 for queuing a data record for delivery to consumer 120, according to an aspect of the invention. In an operation 602, process 306 may be initialized. In an operation 604, if the receiver queue depth is zero, then processing may proceed to an operation 606. In operation 606, if a record count (indicating number of records processed on a prior pass through process 306) is not zero, then processing may proceed to an operation 608, wherein the record count is cleared and processing waits on a timer and returns to operation 604. If in operation 606 the record count is zero, then processing may proceed to an operation 610, wherein processing waits for a receiver post and returns to operation 604. In some implementations, in operation 610, if a shutdown post is received, processing may terminate (not otherwise illustrated in FIG. 6a). The example waiting operations described above facilitate expeditious use of a context switch and/or system dispatch, thereby minimizing use of computer processing resources without delaying delivery of data records to consumer 120.

Returning to operation 604, if the receiver queue depth is not zero, the receiver queue may be de-queued and extracted in an operation 612 and processing may proceed to an operation 614. In operation 614, if the queue depth exceeds a predefined threshold, which may be configurable based upon system resources, processing may proceed to an operation 616. In operation 616, if a secondary process is available, then processing may proceed to an operation 618, wherein a secondary task may be posted and processing proceeds to an operation 622, wherein a record is extracted from the previously extracted receiver queue (as described in operation 612) for processing and a record count indicating the number of records processed this pass may be incremented and processing proceeds to an operation 624. The secondary task may perform processing similar to process 306, thereby facilitating efficient delivery of data records when needed, such as when system 100 experiences high system loads. If in operation 616 a secondary process is not available, processing may proceed to operation 622.

In operation 624, if the record identifier for the extracted record is not in range (such as when no longer valid or wanted), processing may proceed to an operation 640 (illustrated in FIG. 6b), wherein the record identifier may be purged and processing proceeds to an operation 642 (illustrated in FIG. 6b), described below. If in operation 624 the record identifier for the extracted record is in range, then processing may proceed to an operation 628 (illustrated in FIG. 6b), wherein the consumer record index entry for the record identified by the record identifier may be located. For example, process 306 may maintain a pointer to the consumer record table. The record identifier for the extracted record may be multiplied by the size of the index entry of the consumer record table, thereby yielding the offset of the index entry for the extracted record. Processing may proceed to an operation 630.

In operation 630, a determination may be made whether one or more consumers 120 are interested in the extracted record. For example, the determination may be based on a first type of index entry that indicates whether one or more consumers 120 registered an interest in a particular data record and a second type of index entry that indicates whether one or more consumers 120 registered an interest in all data records. In an operation 632, the first type of index entry, which may be a non-zero value, may be examined. For example, when the index entry is non-zero, and an interested consumer count is non-zero in operation 632, at least one consumer 120 registered an interested in the particular data record for which the index was located in operation 628. If the interested consumer count is not zero in an operation 632, then processing may proceed to an operation 634, wherein registration blocks of interested consumers may be processed as described below in relation to an operation 638. Processing may proceed to an operation 636, wherein the second type of index entry may be examined to determine whether at least one consumer 120 has registered an interest in all data records, which may be indicated when the index entry is non-zero. Returning to operation 632, if the interested consumer count is zero, then processing may proceed to operation 636.

In operation 636, if no consumers 120 have expressed interest in all data records, processing may proceed to an operation 640, wherein the extracted record is purged. On the other hand, if in operation 636, at least one consumer 120 has registered an interest in all data records, processing may proceed to operation 638. In this case, the address of a first block that includes the registration block address of interested consumers 120 is extracted from the index entry. The registration block includes information identifying consumer queues for each consumer 120 interested in the extracted record. In some implementations, the registration block 220 includes additional criteria 232 included by consumer 120 when registering for the extracted record. In this manner, the additional criteria 232 may be used to determine whether the extracted record is interesting to consumer 120. Thus, data records that are not interesting may be purged early in the process. When a consumer 120 interested in the extracted data record is identified, the extracted data record may be added to a consumer queue for consumer 120. When all interested consumers 120 have been processed, processing may proceed to operation 640, wherein the extracted record is purged.

In some implementations, when an extracted data record is purged, the buffer index component is examined to determine if it contains a dynamic data buffer component. If the buffer index component points to a dynamic buffer data component, the two are separated and the dynamic data component is freed and available for reallocation by the operating system. The dynamic buffer index component is then returned to the free queue from which it was originally allocated in operation 504. If the buffer index component indicates a static buffer, the buffer data component remains attached to the buffer index component; the buffer index component is then returned to the free queue from which it was originally allocated in operation 504.

When the buffer index component is initialized for the first time, the token representing the queue to which it belongs is stored in the buffer index component, thereby efficiently returning the buffer index component to the free queue to which it belongs by specifying the token that substantially serves as an anchor of the appropriate storage pool management block.

Upon purging the extracted data record, processing may proceed to an operation 642, wherein a determination is made whether the extracted receiver queue depth is zero. If the extracted receiver queue depth is zero, processing may return to operation 604 (illustrated in FIG. 6a). On the other hand, if the extracted receiver queue depth is not zero, processing may return to operation 622 (illustrated in FIG. 6a).

By continuously processing data records off the extracted receiver queue and examining the receiver queue for additional data records which may have been queued by producer 110 processes while the queuing process was processing the extracted receiver queue, the ability to process many more data records may be achieved without an intervening wait or context switch.

Furthermore, waiting on a timer and allowing the receiver queue to build such that multiple records may be processed in a single context switch may reduce the consumption of computing resources when each data record results in the overhead associated with a context switch.

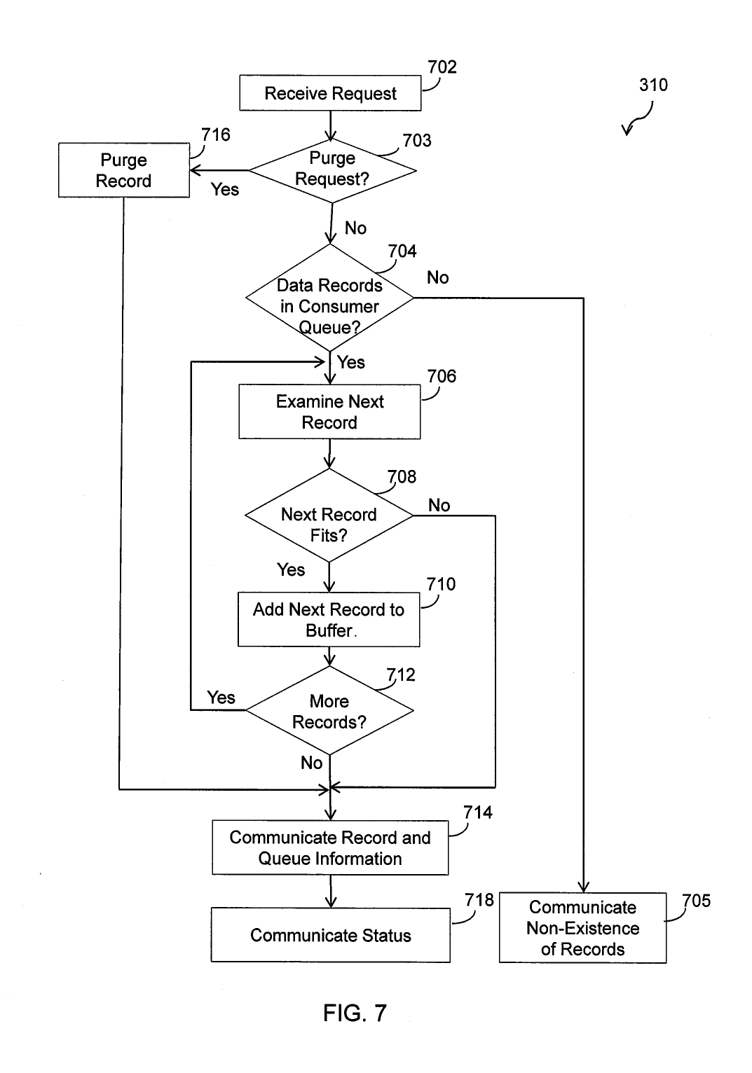

FIG. 7 is a flow diagram of a process 310 for providing a data record to consumer 120, according to an aspect of the invention. In some implementations, execution of process 310 may be executed by consumer 120, thereby addressing the problem of context switching. In an operation 702, a request may be received from consumer 120. The request may include a request to retrieve a data record and/or purge a data record. The request may include an address and/or size of a consumer-provided buffer for retrieving the data record. In this implementation, consumer 120 may issue a cross-memory program call, passing the address of a control block that includes, among other items, the address and size of a consumer-provided buffer in its local storage for retrieving the data record (which may be referred to as the secondary address space from the perspective of prioritizer 130). In other implementations, consumer 120 may pass an ALET, which identifies the space in which the consumer-provided buffer exists. In an operation 703, if the request is a request to purge a data record, then processing may proceed to an operation 716, wherein the next data record is purged. In operation 703, if the request is not a request to purge a data record, then processing may proceed to an operation 704, wherein a determination whether data records exist in a consumer queue for consumer 120 is made. In operation 704, if data records do not exist in the consumer queue, then in an operation 705, consumer 120 may be notified that there are no data records. In operation 704, if data records exist in the consumer queue, then a data record may be examined for the buffer space as described by an operation 708. As previously noted, the request from consumer 120 may include both a request to retrieve a data record and a request to purge a data record. In this implementation, both operation 704 and operation 7 may be performed (not otherwise illustrated in FIG. 7).

In operation 708, if the next data record to be presented to consumer 120 will not fit in the consumer-provided buffer (such as when the next data record exceeds the remaining memory allocated to the consumer-provided buffer), processing may proceed to an operation 714, wherein information indicating size of the next available data record (if any), information related to any data records that were placed in the consumer-provided buffer, and/or other information may be communicated to consumer 120. Processing may proceed to an operation 718, wherein a status is communicated to consumer 120. The status may include, among other information, whether the data record was successfully provided to the consumer buffer provided by consumer 120 and/or the success or failure of any requested purge request. In this manner, consumer 120 may make decisions based on the status and/or other information communicated to consumer 120. For example, when the next data record will not fit in the consumer-provided buffer, consumer 120 may allocate another buffer, empty the existing consumer-provided buffer in order to receive the data record, or request to purge the data record. Consumer 120 may communicate another request based on the decision. Thus, process 310 may receive another request as described in operation 702.

Returning to operation 708, if the next data record to be presented will fit in the consumer-provided buffer, processing may proceed to an operation 710, wherein the next data record to be presented is extracted from the queue and the data contained in the buffer data component of the data record may be added to the buffer provided by consumer 120. In some implementations, the data record may be purged as described above in relation to FIG. 6 or as described in relation to operation 716. In an operation 712, a determination whether more data records are in the consumer queue may be made. If more records are in the consumer queue, processing may return to operation 706, wherein the next data record to be presented to consumer 120 is examined. If in operation 712 no more data records are in the consumer queue, then processing may proceed to operation 714, which is described above.

Implementations of the invention may be made in hardware, firmware, software, or any suitable combination thereof. Implementations of the invention may also be implemented as instructions stored on a machine-readable medium, which may be read and executed by one or more processors. A tangible machine-readable medium may include any mechanism for storing or transmitting information in a form readable by a machine (e.g., a computing device). For example, a tangible machine-readable storage medium may include read only memory, random access memory, magnetic disk storage media, optical storage media, flash memory devices, and other tangible storage media. Intangible machine-readable transmission media may include intangible forms of propagated signals, such as carrier waves, infrared signals, digital signals, and other intangible transmission media. Further, firmware, software, routines, or instructions may be described in the above disclosure in terms of specific exemplary implementations of the invention, and performing certain actions. However, it will be apparent that such descriptions are merely for convenience and that such actions in fact result from computing devices, processors, controllers, or other devices executing the firmware, software, routines, or instructions.

Implementations of the invention may be described as including a particular feature, structure, or characteristic, but every aspect or implementation may not necessarily include the particular feature, structure, or characteristic. Further, when a particular feature, structure, or characteristic is described in connection with an aspect or implementation, it will be understood that such feature, structure, or characteristic may be included in connection with other implementations, whether or not explicitly described. Thus, various changes and modifications may be made to the provided description without departing from the scope or spirit of the invention. As such, the specification and drawings should be regarded as exemplary only, and the scope of the invention to be determined solely by the appended claims.

What is claimed is:

1. A method of prioritizing event data storage and distribution by a data prioritizer device, the method comprising:
receiving, by the data prioritizer device, a registration from a consumer, wherein the registration includes one or more event identifiers that identify one or more event records in which the consumer is interested;
receiving, by the data prioritizer device, an event record from a producer, the event record identified by an event identifier;
storing, by the data prioritizer device, the event record when the event identifier is among the one or more event identifiers, thereby storing the event record when the consumer has indicated an interest in the event record;
queuing, by the data prioritizer device, the event record in a consumer queue allocated for the consumer; and
providing, by the data prioritizer device, the data record to the consumer from the consumer queue.

2. The method of claim 1, further comprising:
purging the event record when the event identifier is not among the one or more event identifiers, thereby indicating that the consumer is not interested in the event record.

3. The method of claim 1, further comprising:
receiving a second event record from a second producer, wherein said storing the event record further comprises queuing the event record in a prioritizer queue that includes the event record and the second event record.

4. The method of claim 1, wherein the event record is provided to the consumer via a consumer-provided buffer.

5. The method of claim 4, the method further comprising:
selecting the consumer queue using one or more pointers that indicate the registration of the event record by the consumer, thereby identifying the consumer, the event record requested by the consumer, and the consumer queue used for delivery of the event record.

6. The method of claim 1, wherein said receiving the event record is run on a first process initiated by the producer and wherein said providing the event record is run on a second process initiated by the consumer, thereby providing multi-process event distribution.

7. The method of claim 1, wherein the registration further includes an instruction from the consumer to notify the consumer when the event record is in the consumer queue, wherein said notifying is based on the instruction.

8. The method of claim 1, said queuing the event record further comprising:
queuing a second event record substantially in parallel with said queuing the event record.

9. The method of claim 1, further comprising:
notifying, by the data prioritizer device, the consumer when the event record has been stored; and
receiving, by the data prioritizer device, a request from the consumer to provide the data record, wherein said providing is in response to the request.

10. A method of distributing data by a data prioritizer device, the method comprising:
receiving, by the data prioritizer device, a registration from a consumer, wherein the registration includes one or more record identifiers that identify one or more records in which the consumer is interested;
receiving, by the data prioritizer device, a data record from a producer, the data record identified by a record identifier;
storing, by the data prioritizer device, the data record when the record identifier is among the one or more record identifiers, thereby indicating the consumer is interested in the data record;
receiving, by the data prioritizer device, a request from the consumer to provide the data record; and
providing, by the data prioritizer device, the data record to the consumer.

11. A method of distributing data by a data prioritizer device, the method comprising:
receiving, by one or more processors of the data prioritizer device, a registration from a consumer, wherein the registration includes one or more record identifiers that identify one or more data records in which the consumer is interested;
storing the registration; and
providing the one or more record identifiers to a producer of the one or more data records, wherein the producer uses the one or more record identifiers to determine whether to generate the one or more data records based on whether the one or more data records is registered.

12. A system of prioritizing event data storage and distribution, the system comprising:
a prioritizer device configured to:
receive a registration from a consumer, wherein the registration includes one or more event identifiers that identify one or more event records in which the consumer is interested;
receive an event record from a producer, the event record identified by an event identifier;
store the event record when the event identifier is among the one or more event identifiers, thereby storing the event record when the consumer has indicated an interest in the event record;
queue the event record in a consumer queue allocated for the consumer; and
provide the data record to the consumer from the consumer queue.

13. The system of claim 12, the prioritizer device further configured to:
purge the event record when the event identifier is not among the one or more event identifiers, thereby indicating that the consumer is not interested in the event record.

14. The system of claim 12, the prioritizer device further configured to:
receive a second event record from a second producer, wherein said storage of the event record further comprises queuing of the event record in a prioritizer queue that includes the event record and the second event record.

15. The system of claim 12, wherein the event record is provided to the consumer via a consumer-provided buffer.

16. The system of claim 15, the prioritizer device further configured to:
select the consumer queue using one or more pointers that indicate the registration of the event record by the consumer, thereby identifying the consumer, the event record requested by the consumer, and the consumer queue used for delivery of the event record.

17. The system of claim 12, wherein said receipt of the event record is on a first process initiated by the producer and wherein said provisioning of the event record is run on a second process initiated by the consumer, thereby providing multi-process event distribution.

18. The system of claim 12, wherein the registration further includes an instruction from the consumer to provide a notification to the consumer when the event record is in the consumer queue, wherein said notification is based on the instruction.

19. The system of claim 12, during said queuing of the event record, the data prioritizer device is further configured to:
queue a second event record substantially in parallel with said queuing the event record.

20. The system of claim 12, the prioritizer device further configured to:
notify the consumer when the event record has been stored; and
receive a request from the consumer to provide the data record, wherein said provisioning of the data record is in response to the request.

21. A system of distributing data, the system comprising:
a data prioritizer device configured to:
receive a registration from a consumer, wherein the registration includes one or more record identifiers that identify one or more records in which the consumer is interested;
receive a data record from a producer, the data record identified by a record identifier;
store the data record when the record identifier is among the one or more record identifiers, thereby indicating the consumer is interested in the data record;
receive a request from the consumer to provide the data record; and
provide the data record to the consumer.

22. A system of distributing data, the system comprising:
a data prioritizer device configured to:
receive a registration from a consumer, wherein the registration includes one or more record identifiers that identify one or more data records in which the consumer is interested;
store the registration; and
provide the one or more record identifiers to a producer of the one or more data records, wherein the producer uses the one or more record identifiers to determine whether to generate the one or more data records based on whether the one or more data records is registered.

23. A computer readable storage medium including instructions for prioritizing event data storage and distribution, the instructions when executed by one or more processors configuring the one or more processors to:
receive a registration from a consumer, wherein the registration includes one or more event identifiers that identify one or more event records in which the consumer is interested;
receive an event record from a producer, the event record identified by an event identifier;
store the event record when the event identifier is among the one or more event identifiers, thereby storing the event record when the consumer has indicated an interest in the event record;
queue the event record in a consumer queue allocated for the consumer; and
provide the data record to the consumer from the consumer queue.

24. The computer readable storage medium of claim 23, the instructions when executed further configuring the one or more processors to:
purge the event record when the event identifier is not among the one or more event identifiers, thereby indicating that the consumer is not interested in the event record.

25. The computer readable storage medium of claim 23, the instructions when executed further configuring the one or more processors to:
receive a second event record from a second producer, wherein said storage of the event record further comprises queuing of the event record in a prioritizer queue that includes the event record and the second event record.

26. The computer readable storage medium of claim 23, wherein the event record is provided to the consumer via a consumer-provided buffer.

27. The computer readable storage medium of claim 26, the instructions when executed further configuring the one or more processors to:
select the consumer queue using one or more pointers that indicate the registration of the event record by the consumer, thereby identifying the consumer, the event record requested by the consumer, and the consumer queue used for delivery of the event record.

28. The computer readable storage medium of claim 23, wherein said receipt of the event record is on a first process initiated by the producer and wherein said provisioning of the event record is run on a second process initiated by the consumer, thereby providing multi-process event distribution.

29. The computer readable storage medium of claim 23, wherein the registration further includes an instruction from the consumer to provide a notification to the consumer when the event record is in the consumer queue, wherein said notification is based on the instruction.

30. The computer readable storage medium of claim 23, wherein during said queuing of the event record, the instructions when executed further configure the one or more processors to:
queue a second event record substantially in parallel with said queuing the event record.

31. The computer readable storage medium of claim 23, the instructions when executed further configuring the one or more processors to:
notify the consumer when the event record has been stored; and
receive a request from the consumer to provide the data record, wherein said provisioning of the data record is in response to the request.

32. A computer readable storage medium including instructions for distributing data, the instructions when executed by one or more processors configuring the one or more processors to:
receive a registration from a consumer, wherein the registration includes one or more record identifiers that identify one or more records in which the consumer is interested;
receive a data record from a producer, the data record identified by a record identifier;
store the data record when the record identifier is among the one or more record identifiers, thereby indicating the consumer is interested in the data record;
receive a request from the consumer to provide the data record; and
provide the data record to the consumer.

33. A computer readable storage medium including instructions for distributing data, the instructions when executed by one or more processors configuring the one or more processors to:
receive a registration from a consumer, wherein the registration includes one or more record identifiers that identify one or more data records in which the consumer is interested;
store the registration; and
provide the one or more record identifiers to a producer of the one or more data records, wherein the producer uses the one or more record identifiers to determine whether to generate the one or more data records based on whether the one or more data records is registered.
